(19) United States
(12) Patent Application Publication
(10) Pub. No.: US 2007/0118531 A1
(43) Pub. Date: May 24, 2007

(54) Issues database system and method

(75) Inventors: Phil J. Gatton, Louisville, KY (US); William D. Fowler, Louisville, KY (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/283,014

(22) Filed: Nov. 18, 2005

(51) Int. Cl. G06F 17/30

(52) U.S. Cl. 707/10

(57) ABSTRACT

A graphical interface provides multi-faceted distributed access to project information stored in one or more databases. A plurality of users having different types of functions can access data related to their respective function to the exclusion of information for the same project related to other functions.

### FIELD

The invention pertains to systems and methods that enable a variety of different users to enter or to access data presented in a database relative to a common activity. More particularly, the invention pertains to such systems and methods that selectively receive or provide information associated with a selected project related function to the exclusion of information associated with other project related functions.

### BACKGROUND

Relational databases have become a well-known and very usable type of structure for storing and retrieving information in connection with complex processes. Languages such as SUL have been developed and are available as tools for interacting with and accessing the data in such databases.

Graphical user interfaces have been developed to facilitate access to the data in such databases. One of the advantages of such interfaces is that the users are able to access, modify and store all data without any need to understand and directly become involved with the underlying processing associated the basic operation of such databases.

The software development life cycle includes multiple phases and involves participants representing different functions. Typically, a marketing or product management function or team determines a market need for a particular software application. That team then defines the customer's requirements and generates functional specifications (i.e. what is to be created) for the proposed product by working with an engineering team/function.

The software engineering team (or function) then takes this description of what is to be and creates a document called a design (or engineering) specification describing how the product will be designed. For organizations using Design For Six Sigma methodology, these specification items are linked to each other conceptually using a tool called a Quality Function Deployment (QFD) matrix that ensures the features included in the product do in fact address the customer's primary concerns. As part of the design specification effort, the engineering team/function often employs another tool called a Design Failure Mode and Effects Analysis (DFMEA) to plan for what could go wrong with the product and how to avoid or mitigate such failure modes.

An independent testing organization then can use the specifications and the DFMEA to generate a test plan document, which is then executed and reported in a test results document. Defect data are typically kept in a stand alone defect tracking system.

After the product has been released, the technical support function records information from customers relating to how the product performs in the field. The management function takes all of this information, along with scheduling and labor cost information, and analyzes the efficiency and effectiveness of the effort of each function, the overall product, and the processes used.

Each function typically captures its own information. All of this information is implicitly, conceptually linked, and management can follow the document trail to manually piece together the linkages from each process step. However, to aggregate that data and perform the analysis of the product, the process, the Cost of Software Quality, and the value of the effort, takes more time and energy than should be necessary.

There continue to be ongoing problems that confront organizations in managing new project development, structural changes to projects in development, and metrics for a given project. There also continue to be difficulties in storing organizational knowledge so that it is both relational and capable of efficiently supporting product development, and, in a way that can provide audit trails as to the changes that were made over a period of time.

Thus there needs to be a need for interfaces which can serve a wide variety of individuals associated with a project or product development activity, such as development of a software package. Preferably such interfaces could assist development, testing and tracking as those issues arise during and after the development of the product, including tracking those software changes which have been made to resolve outstanding issues before and after release. It would be desirable to be able to use such interfaces to track defects, to carry out changes to product both during development and after release, as well as to be able to generate metrics and status information.

### BRIEF DESCRIPTION OF THE DRAWING

FIG. 1 is block diagram of a system in accordance with the invention;

FIG. 2 is a summary view illustrating some information on initial or entry screens presented after login;

FIG. 3 illustrates some characteristics and choices from an initial marketing/management screen;

FIG. 4 illustrates some characteristics and choices from an entry development management screen;

FIG. 5 illustrates characteristics and choices from an entry developer screen;

FIG. 6 illustrates characteristics and choices from an entry test management screen;

FIG. 7 illustrates characteristics of and choices from an entry tester screen;

FIG. 8 illustrates characteristics of and choices from an entry technical support screen;

FIG. 9 is a view of the entry marketing/management screen in accordance with FIG. 3;

FIG. 10 illustrates a development engineering management entry screen in accordance with FIG. 4;

FIGS. 11A-11I illustrate subsequent screens accessible by development manager from the entry development manager screen of FIG. 4;

FIG. 12 illustrates a development engineering entry screen in accordance with FIG. 5;

FIGS. 13A-13C illustrate development engineering screens accessible through the entry screen of FIG. 5;

FIG. 13D is a diagram illustrating aspects of an exemplary integrated development environment in which a development engineering organization might operate;

FIG. 14 illustrates an entry test management screen in accordance with FIG. 6;

FIGS. 15A, 15B illustrate test management screens enterable from the screen of FIG. 14;

FIG. 16 illustrates a tester entry screen in accordance with FIG. 7;

FIGS. 17A-17E illustrate tester related screens enterable from the initial tester screen of FIG. 16; and

FIG. 18 illustrates a technical support entry screen.

### DETAILED DESCRIPTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

In accordance with the invention inputs from all of the contributors in a relational database or series of related databases can be captured in the first place, in the course of regular workflows. Tools are provided to automatically generate analysis.

An Interface enables each internal stakeholder to input relevant data that might previously have been captured in a separate unlinked formatted document file or separate information system. The interface therefore presents different views for personnel of different functions (as determined by login) so that each stakeholder is prompted for only the data germane to that function, and is given quickest access to information and reports of interest to that function. In a disclosed embodiment, a graphical user's interface is provided.

Marketing personnel are prompted for marketing inputs and provided outputs germane to marketing. Development engineering personnel are prompted for development inputs and provided outputs germane to development engineering. Likewise the testing, test lead, technical support, and development engineering management screens illustrate first and foremost the data of interest to the respective logged-on user, and prompt for the inputs that user is expected to provide. Additional views can be accessed (if security permits) using an alternate menu.

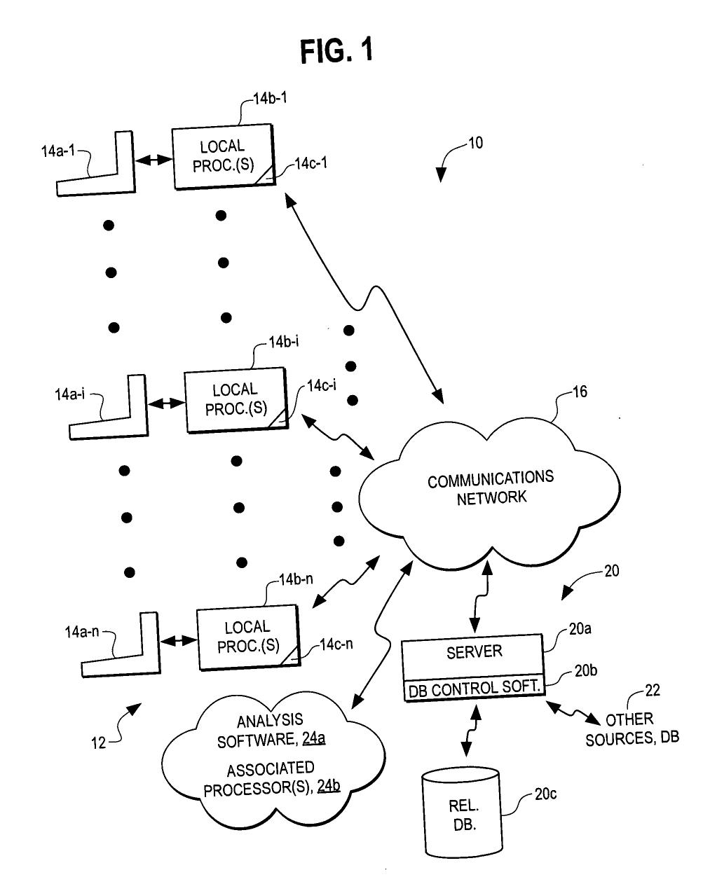

FIG. 1 illustrates a system 10 in accordance with the present invention. The system 10 includes a plurality of access units 12 each of which can incorporate a graphical output device such as device 14a-i which is in turn coupled to and communicates with one or more local processors 14b-i.

In accordance with the invention, the units of a plurality 12 can be dispersed geographically at a variety of locations as is convenient for the product or process being developed. The units 12 can communicate, via their local processors using a communications network 16.

The network 16 could without limitation be implemented as an Internet or an intranet. Those with skill will understand that the units 12 could each incorporate local operational software, such as software 14c-i for the purpose of presenting various types of graphical displays on the display device 14a-i and enabling a user thereof to enter requests thereon or receive information therefrom by means of the communications network 16.

Further in accordance with the invention a database system generally indicated at 20 could be coupled to and in communication with the units 12 via network 16. The system 20 could incorporate one or more processors or servers 28a, local control software for communications and for database management 20b as well as one or more relational databases 20c. As those of skill will understand, the exact nature and structure of the unit 20 is not a limitation of the present invention. Information stored in relational database 20c could be supplemented by or exported to other sources or databases indicated generally at 22 either directly via server 20a or via network 16.

System 10 can also incorporate analysis software 24a which can be executed one or more associated processors 24b. The software and processors 24a,b can be in communication with the units 12 as well as the database system 20 via network 16. It will thus be understood that the units 12 and their associated local software can present data to/receive data from local users on a worldwide basis all without limitation.

It will be understood that the present graphical interface makes it possible for users who log on to one of the units 12 to interact with a variety of screens, discussed in more detail subsequently, which present and receive data associated with that particular individual's or user's function in the development process as determined, for example during log-in. For example and without limitation functions can be categorized as marketing and/or project management, project development management, developer functions, test management, tester functions, as well as on-going technical support.

One type of product or project that could be developed pertains to a software system. Similar functions or categories could be utilized in the development of hardware units or systems. It will be understood that the type of project or product being developed is not a limitation of invention. Further, it will be understood that the respective interface software could be located wholly or in-part at the local processor, such as processor 14b-i, which could include one or more local servers, or at a displaced location all without limitation.

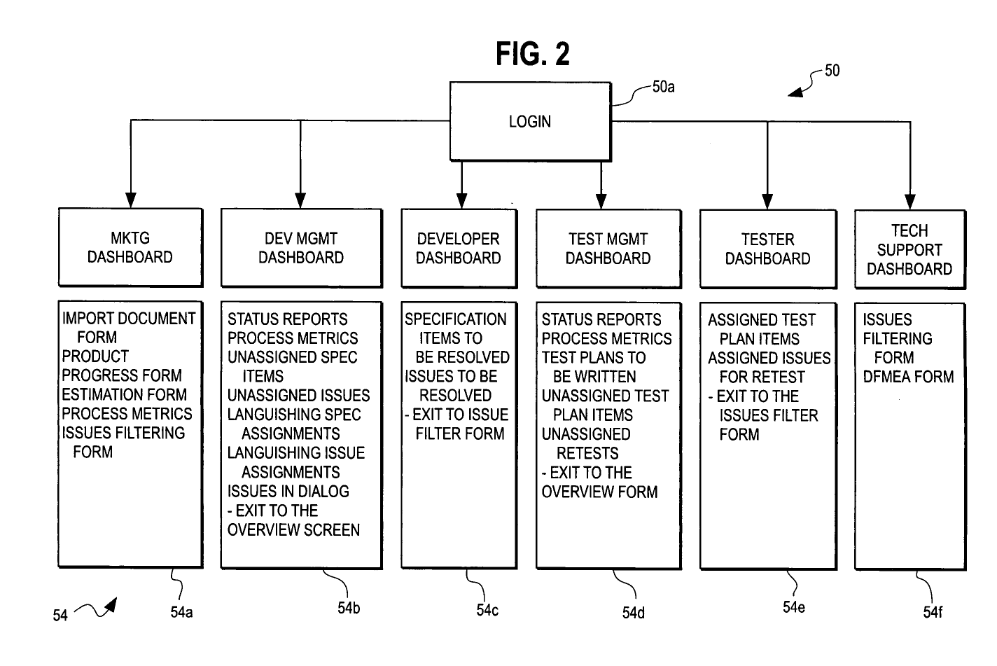

A flow diagram, indicated generally at 50 in FIG. 2 illustrates a plurality of functional project development areas 50 (selected based on log-in information) and summary respective associated initial screens 54. For example, screen 54a could be presented to somebody with a marketing and/or management function, determined from logon information 50a. Other functionally oriented initial screens include a development management screen 54b, a developer screen 54c, task management screen 54d, tester screen 54e, and technical support initial screen 54f. It will be understood that the functions and screens 54 are exemplary only and are not limitations of the present invention.

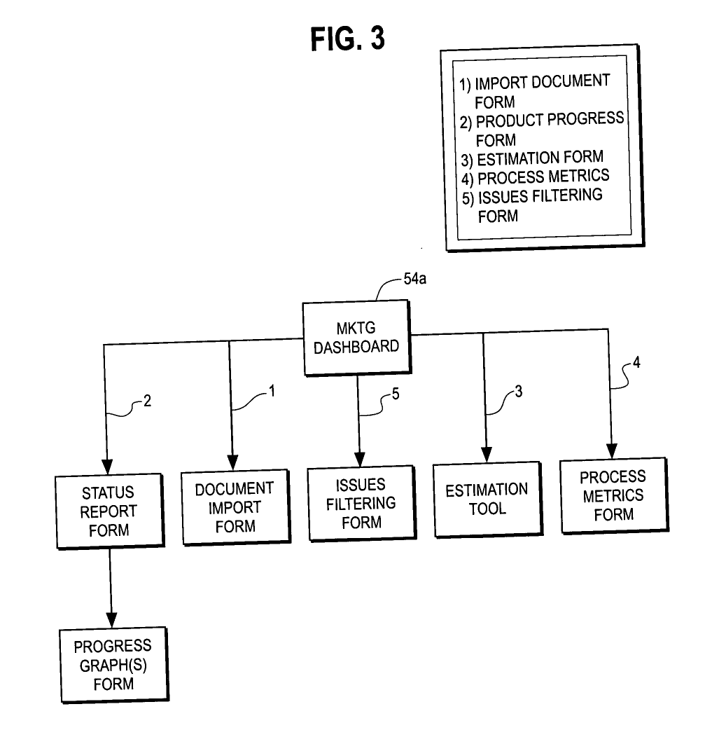

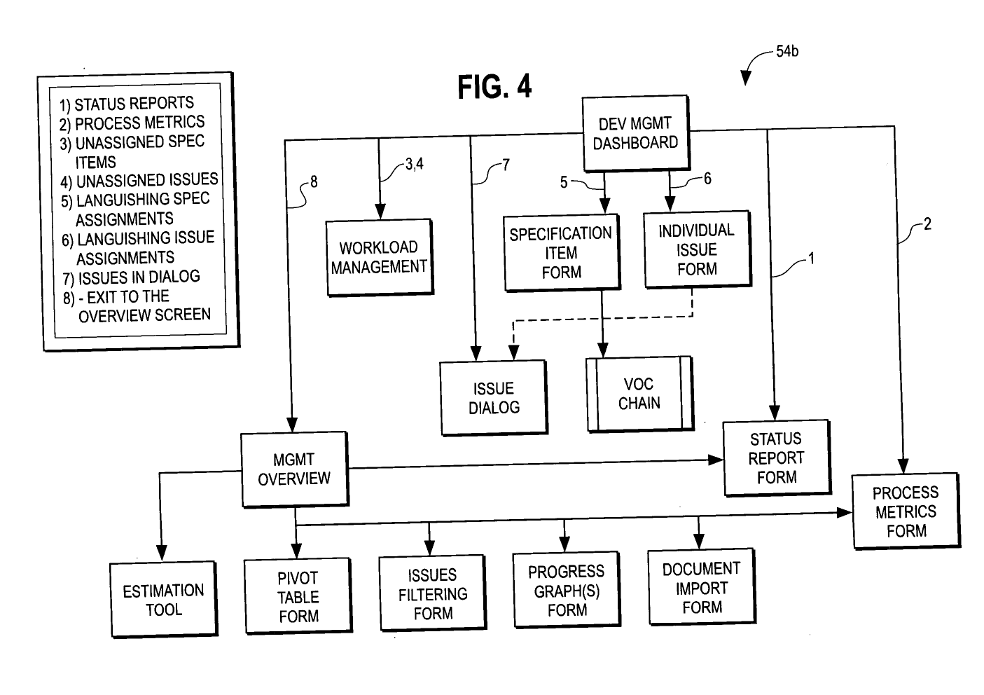

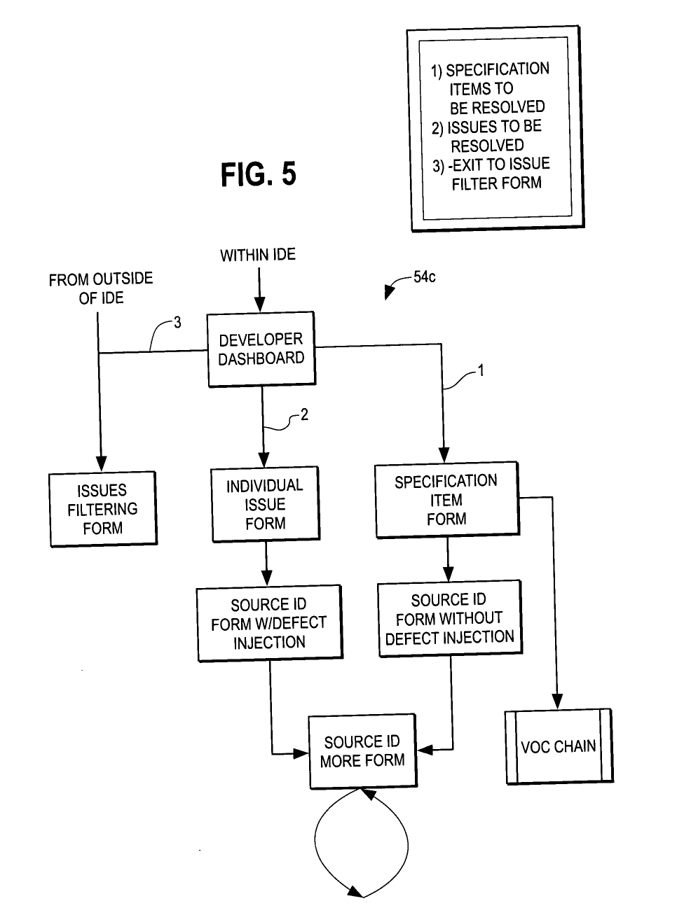

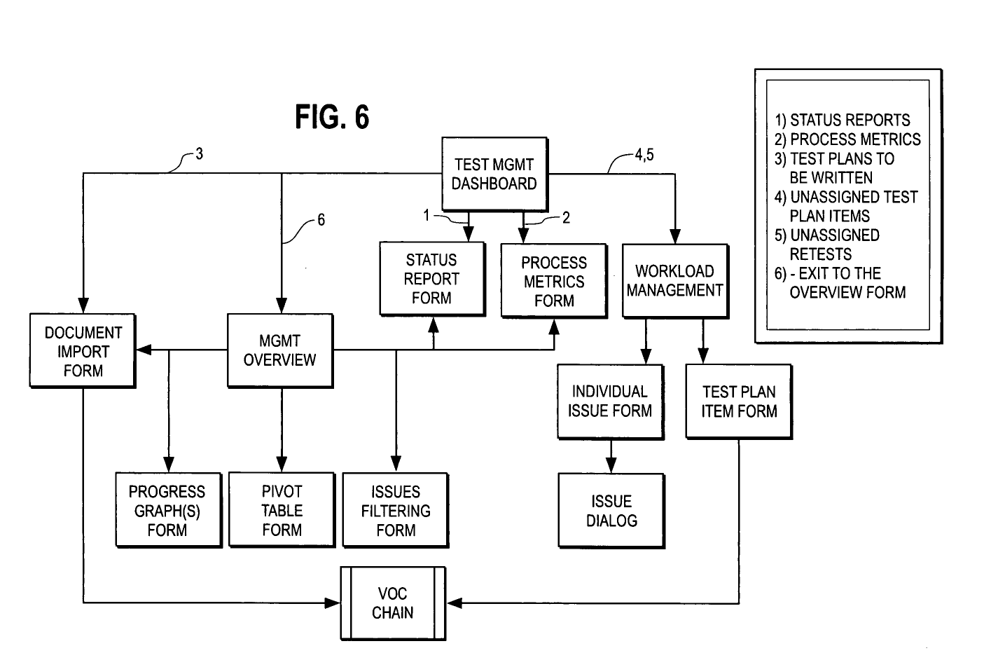

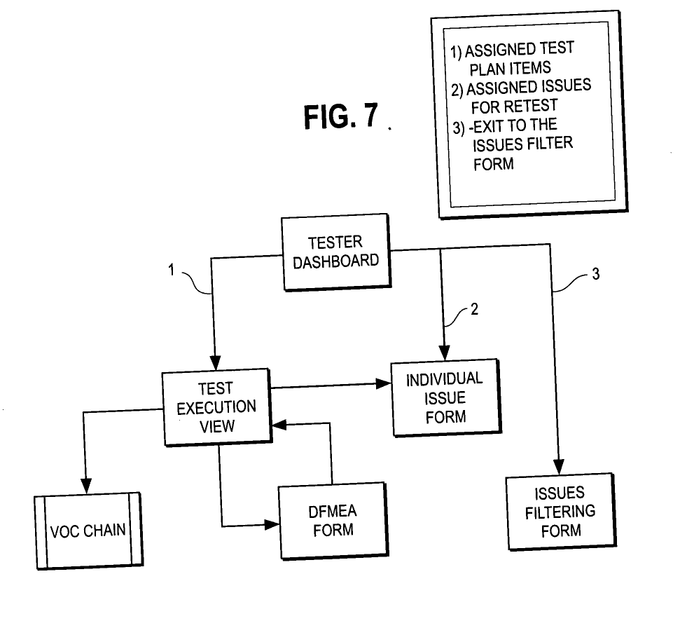

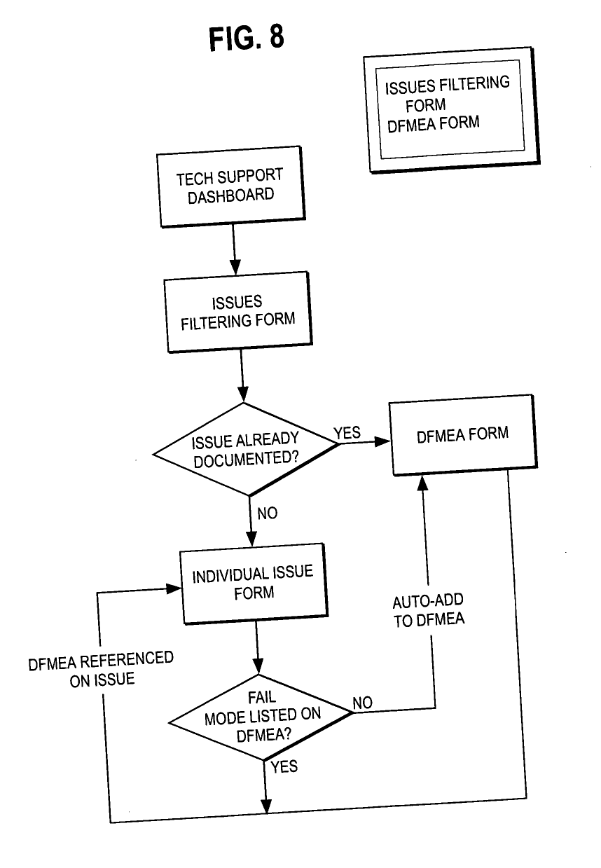

FIGS. 3-8 illustrate additional aspects of the characteristics and subsequent screens associated with each of the initial screens 54. As those with skill will understand, when each of the respective initial screens is presented to a user, not only can data be extracted therefrom but data can be entered. Such data is reflected in the relational database 20c after entry. As a result, project definitional information, project development information, project changes, as well as test information and results will all be reflected in the relational database 20c automatically.

The present system and method is also particularly advantageous in that, as illustrated in FIGS. 3-8, for each of the functions illustrated in FIG. 2, an individual with particular functional responsibilities such as marketing, development, testing or technical support can acquire, use, enter and update information particularly associated with their functional aspect or relationship to the on-going project. These activities take place without the respective individual being burdened, distracted, slowed down by, exposed to or required to go through information associated with other functional aspects of the particular project that do not involve that particular individual's responsibilities.

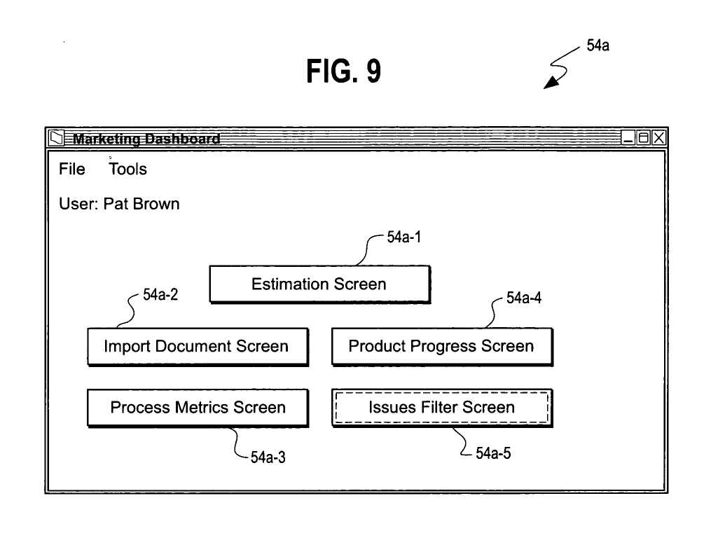

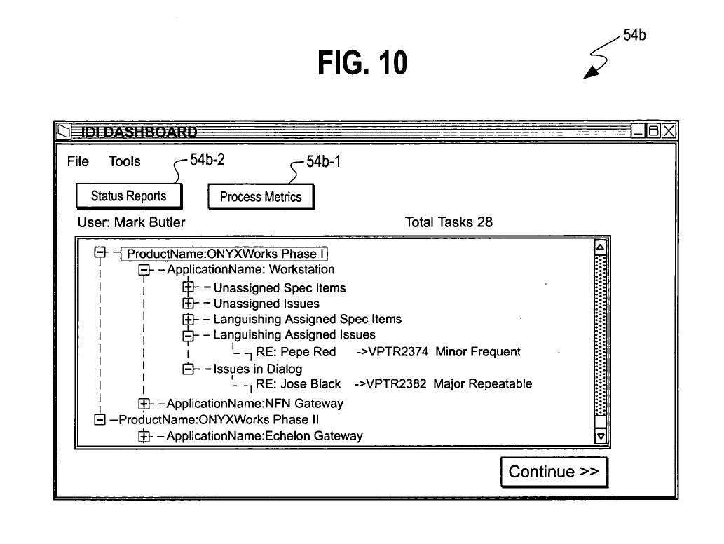

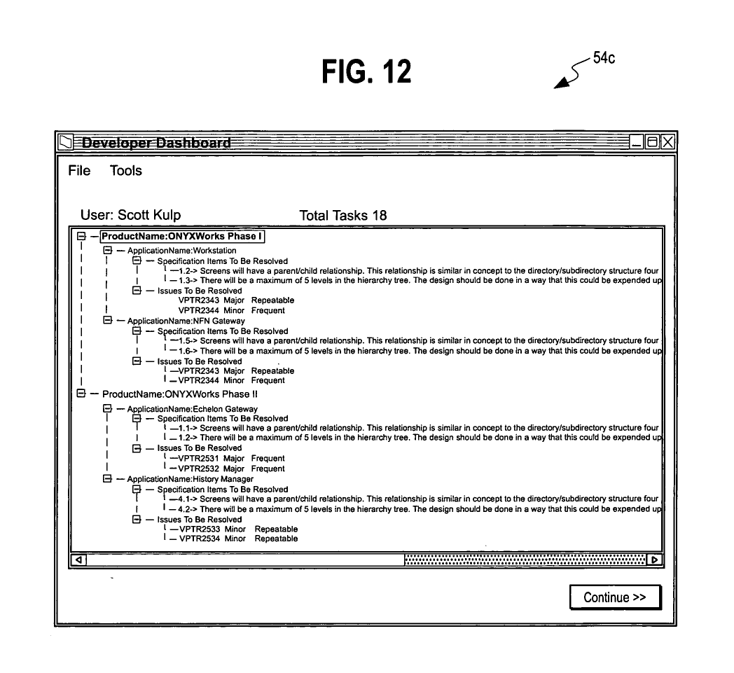

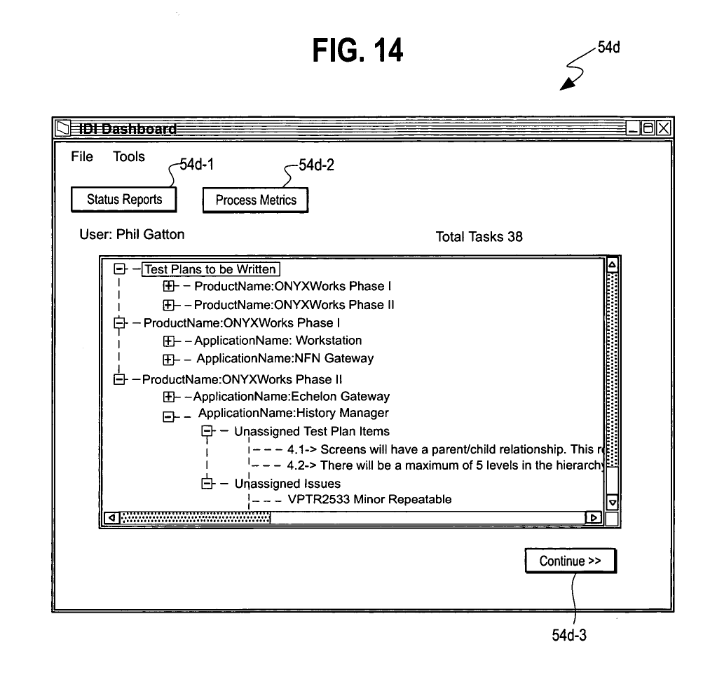

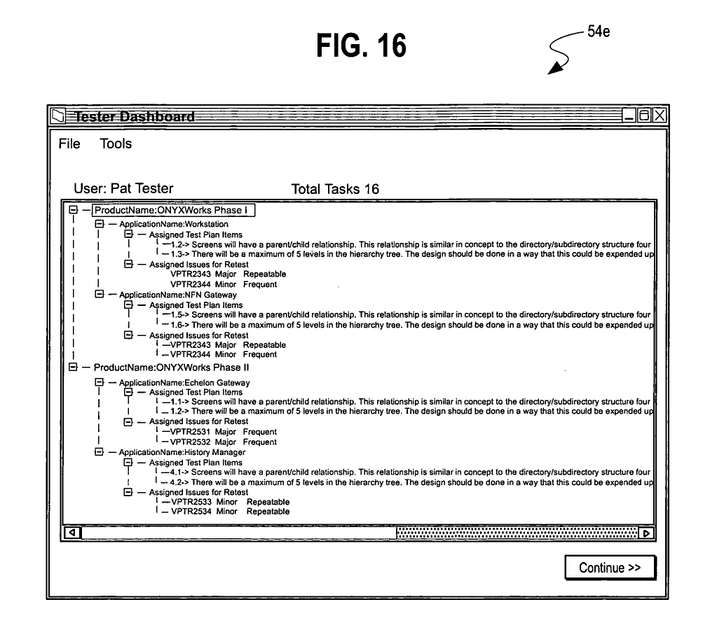

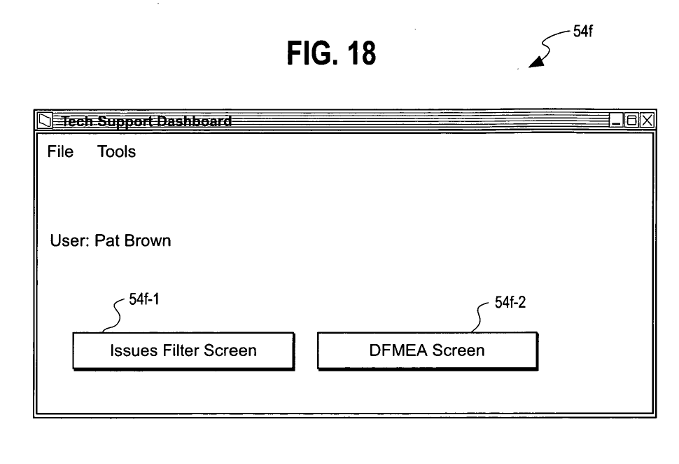

FIG. 9 illustrates an exemplary initial marketing screen 54a. FIG. 10 illustrates an exemplary form of the development management initial screen 54b. FIG. 12 illustrates one form of a developer's initial screen 54c. FIG. 14 illustrates an exemplary form of a test management initial screen 54d. FIG. 16 illustrates an exemplary form of a tester initial screen 54d. FIG. 18 illustrates an exemplary embodiment of an initial technical support screen 54f.

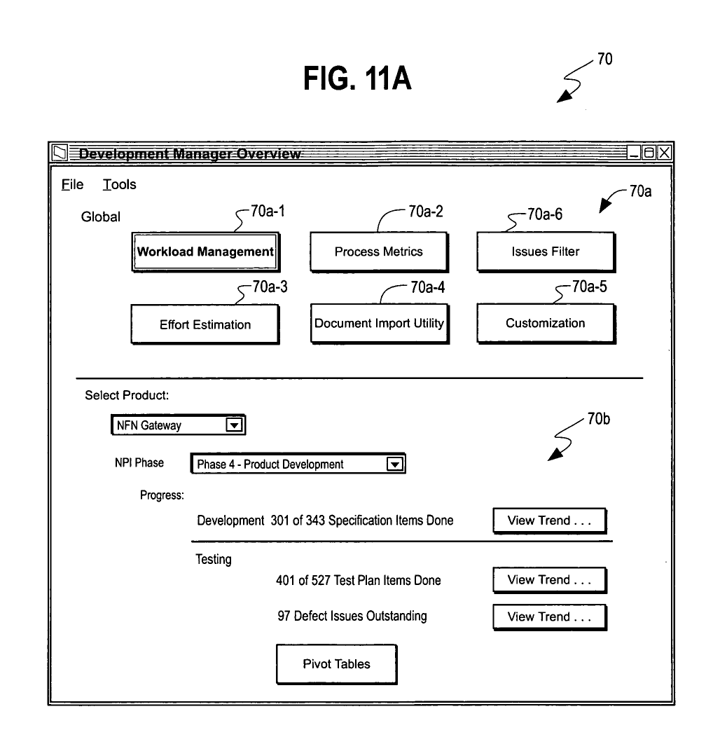

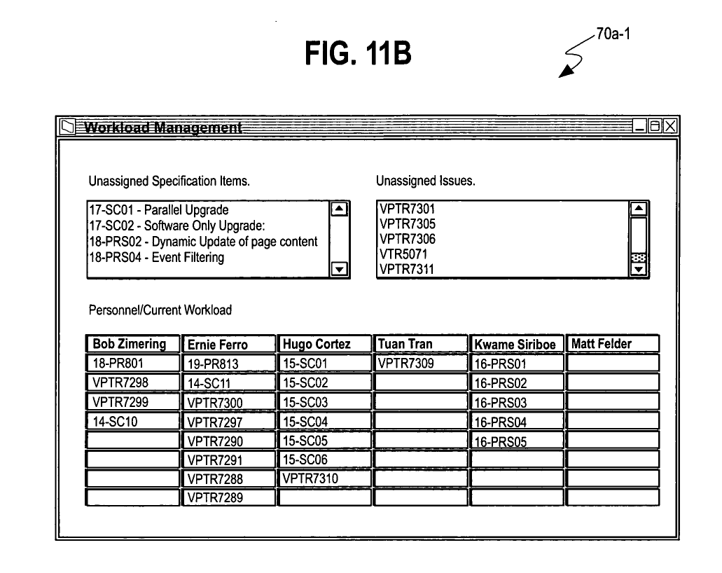

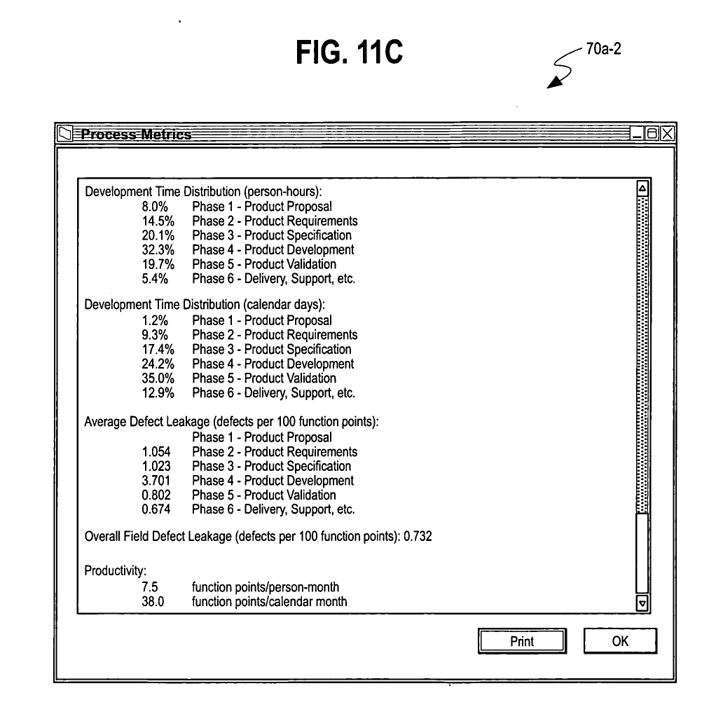

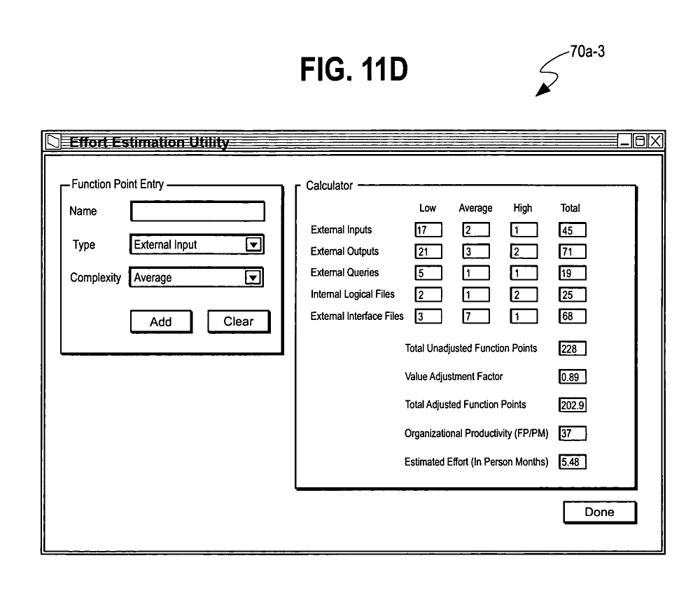

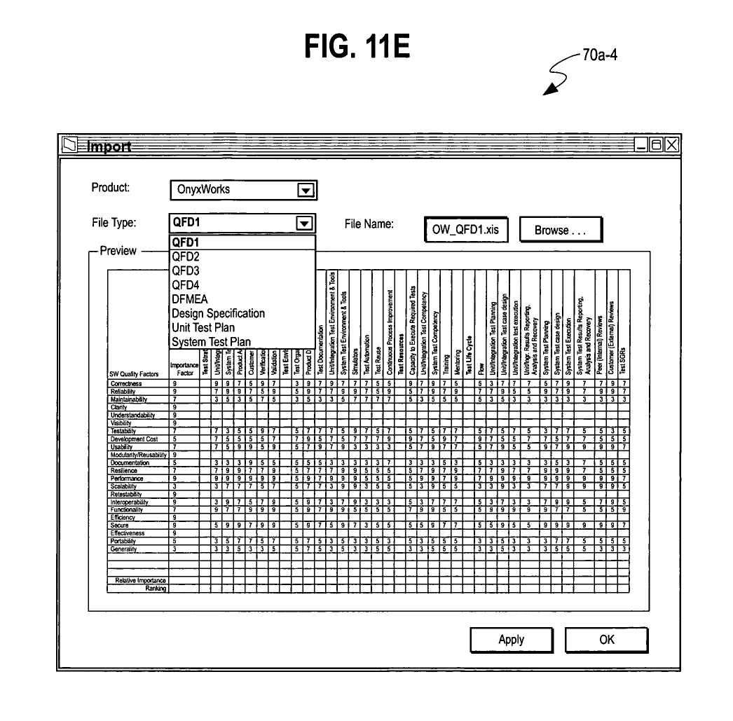

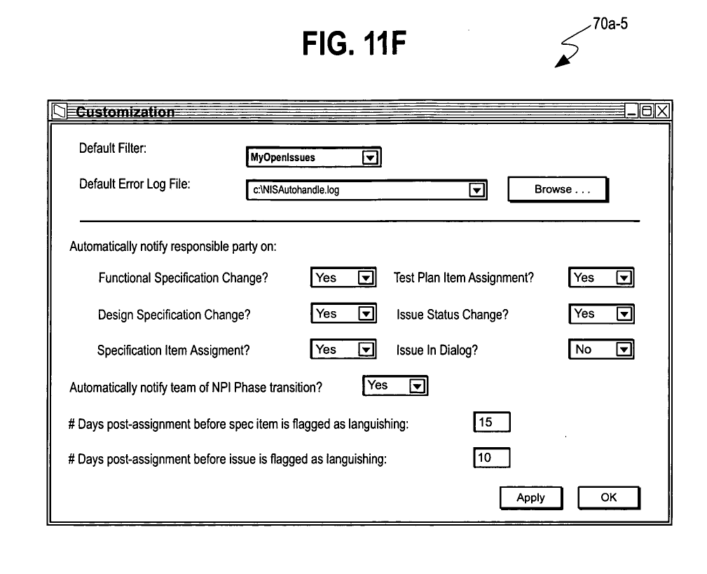

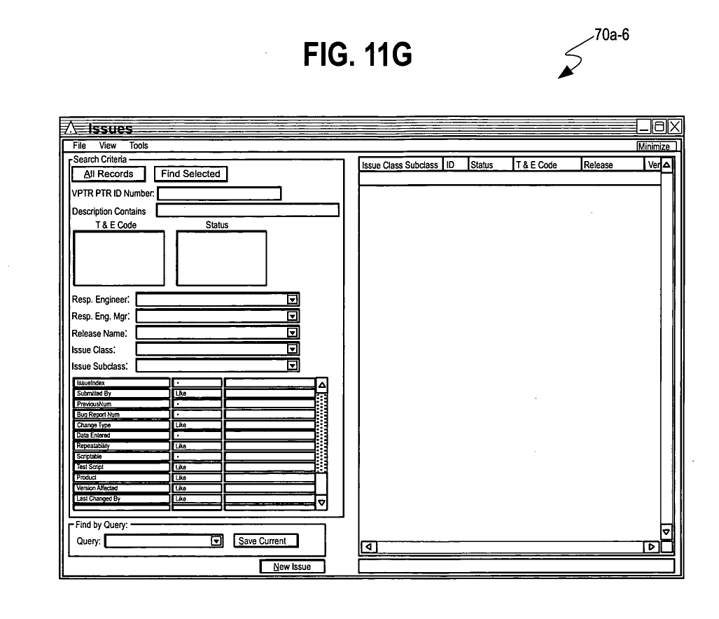

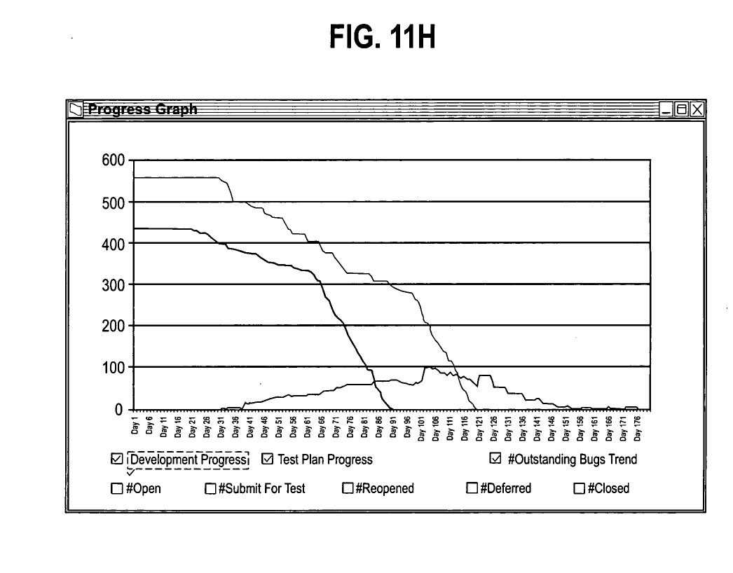

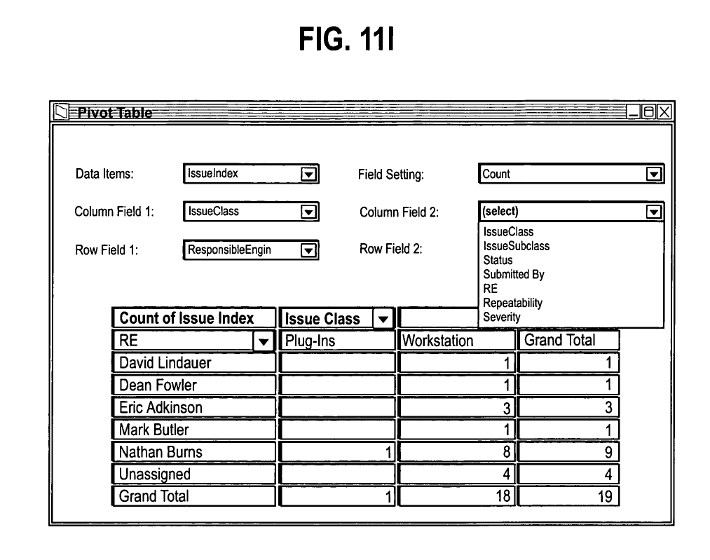

As seen in FIG. 9, the exemplary initial marketing screen presents a series of options to the user. The user can select an Estimation Screen 54a-1 illustrated subsequently in FIG. 11D. This screen enables the user to view an analysis of the external effort associated with the particular design. The user can select an Import Documents Screen 54a-2. The Import Documents Screen 54a-2 enables a user to import functional specifications or high-level QFDs.

A Process Metric Screen can be selected 54a-3. The Process Metric screen, FIG. 11C, enables the user to observe or determine how the organization is performing as a whole.

A Product Progress screen can be selected 54a-4 to observe progress and status as to development of a particular product. Finally, an Issues Filter screen can be selected 54a-5, see FIG. 11G to view outstanding issues.

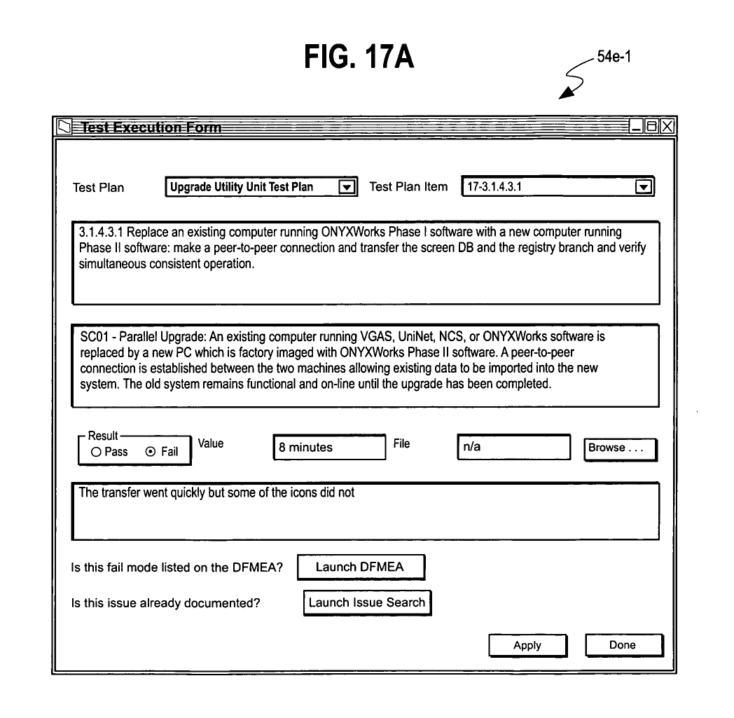

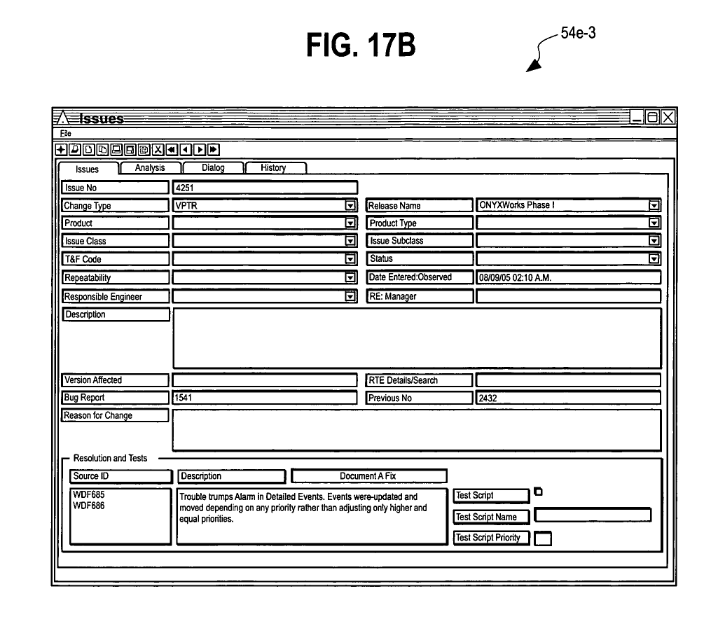

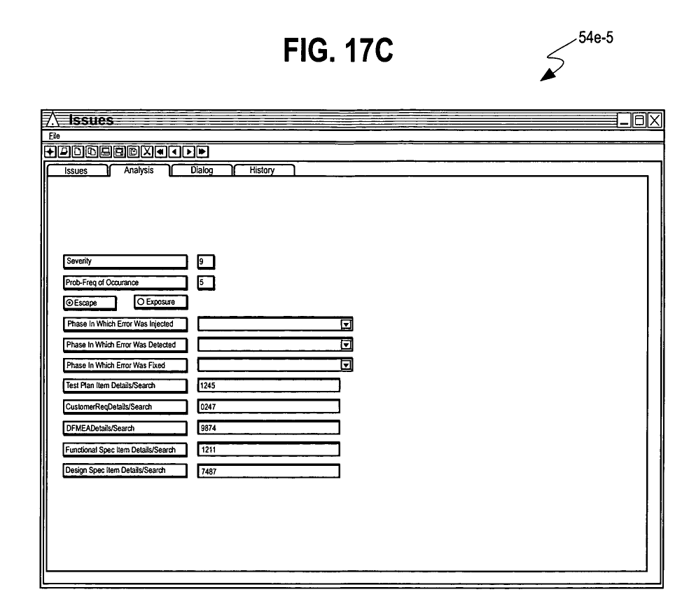

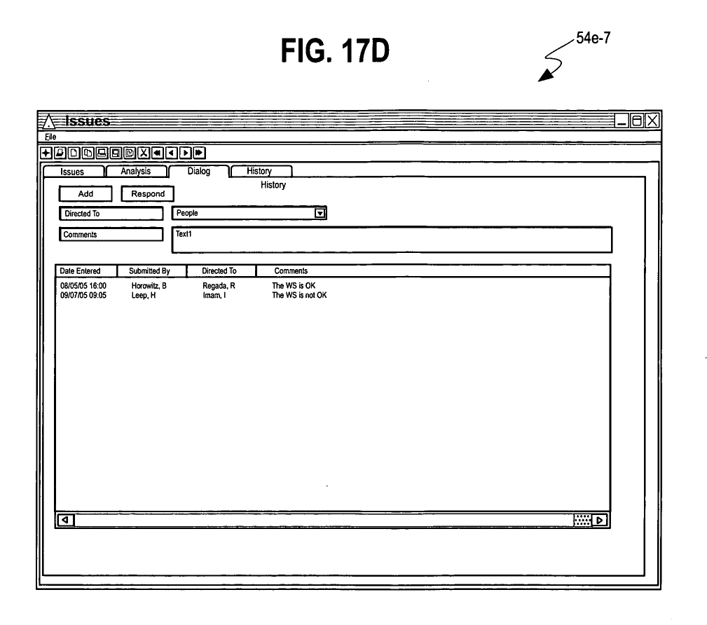

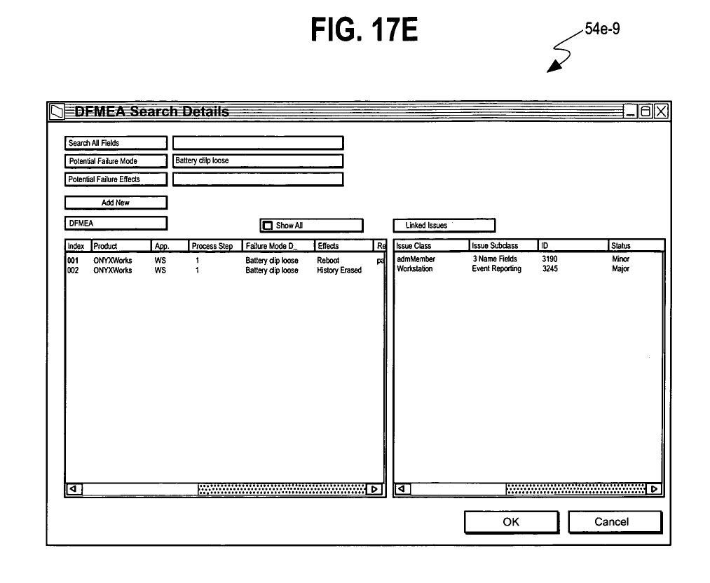

FIG. 10 illustrates the exemplary development engineering management screen 54b. Screen 54b focuses initially on those areas of the development process that are off schedule or problematic and thus have to be managed. These include unfinished or unassigned specifications, bugs, defects or specifications items that have remained unresolved for an extended period of time (or issues that are subject to dialogue between developers and testers, see FIG. 17D.)

Also at screen 54b, a user can directly select a Process Metrics dialogue screen 54b-1 or obtain Status Reports 54-2 relative to particular projects. Further, the user can select any of the displayed items for further work or to go to a default manager's view 70, see FIG. 11A using the “continue” button.

With respect to FIG. 11A, the default manager's overview has a global section 70a and a product specific section 70b. Global screens that can be selected include Workload Management 70a-1, see FIG. 11B, Process Metrics 70a-2, see FIG. 11C, Effort Estimation 70a-3, see FIG. 11D. A document import utility application 70a-4 can selected, see FIG. 11E. A customization screen 70a-5 can selected, see FIG. 11F. Alternately, an Issues Filter screen 70a-6 can be selected, see FIG. 11G.

The workload management screen 70a-1, see FIG. 11B, enables the user to assign tasks to reporting personnel and view each individual's workload. The name of an individual who is in need of assignments can be displayed in a contrasting color such as red.

With respect to the Process Metrics screen 70a-2, as in FIG. 11C, the performance of the organization relative to all products can be viewed for each process to the extent such as present in the databases 20c. The user can also establish metrics over a predetermined range if desired.

Two screens common to marketing management and development management are Effort Estimation Utility screen, FIG. 11D and the Document Import Utility screen, FIG. 11E. Relative to FIG. 11D, the Effort Estimation Utility screen 70a-3 assists users in determining whether proposed projects, and their associated feature sets, are feasible within proposed deadlines. Prompts can be provided for function point counts of each type and complexity. The interface and underlying software can generate expected effort, in person months, to get the project completed. Such calculations can be based on customizing the methodology to an organization based on its historical data. Each new and completed project results in an automatic recalibration of the processing algorithm to provide more accurate estimations.

The Document Import Utility screen 70a-4, see FIG. 11E, can be used by a manager to import documents from other sources 22. The present software then processes and stores those documents in the database 20c for subsequent use. Various types of documents without limitation can be imported. The Document Imports Utility can also sort design specification text into discrete design specification items that become records in the database 20c.

The Custom Designation screen 70a-5, see FIG. 11F, can be used for establishing defaults and notification settings in the subject interface. The customization screen 70a-5 is intended to make it convenient for the users to use the subject interface system.

The Issues Filtering Screen 70a-6, see FIG. 11G, enables the user to search through any prior defect issue/modification request relative to any product. A keyword-based utility can be provided for descriptions and resolutions. Additionally a filtering function can be provided relative to selected or predetermined fields in the database 20c. The user's screen 70a-6 enables the user to save, either globally or for the specific user, and to load predefined filters as well as to create new issues as appropriate.

The screen 70a-6 also enables the development manager not only to launch product independent screens, it also provides a snapshot of the status of any selected product. Once a product has been selected, the user can view and update as appropriate the new product introduction phase, or view the current list of outstanding items in development and testing. A project progress graph, FIG. 11H can be presented by selecting a view trend function. Further, the user can open a pivot table screen, see FIG. 11I, to further analyze the status of the product.

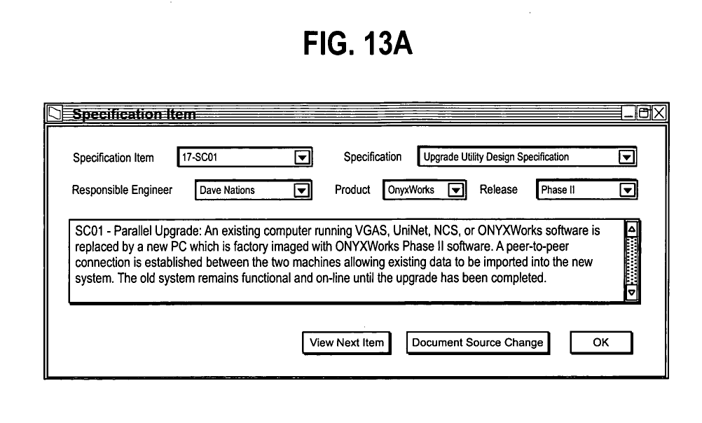

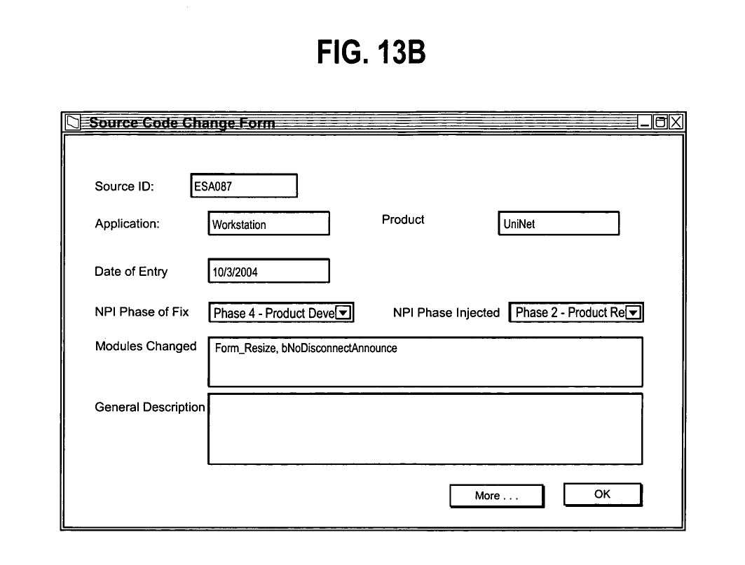

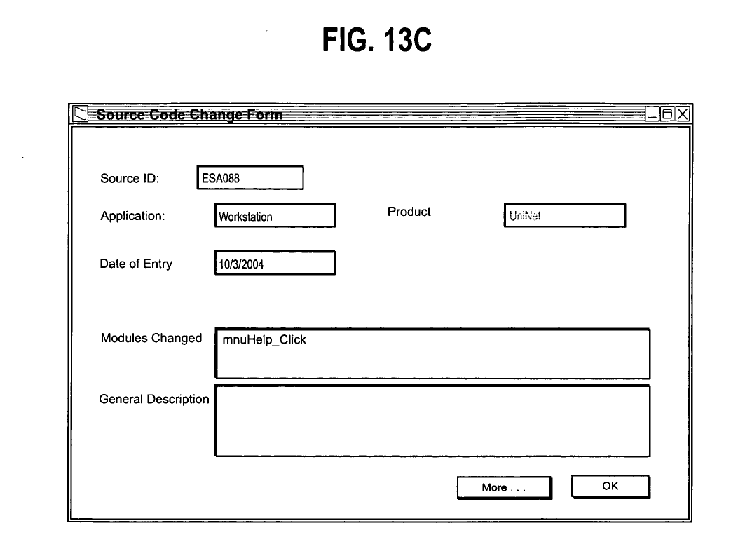

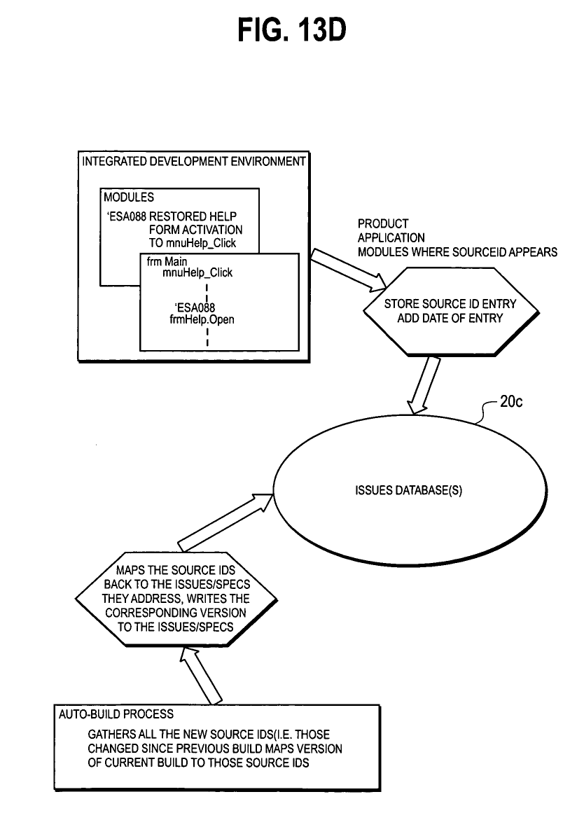

FIG. 12 illustrates the Development Engineering initial screen 54c. The screen 54c can be opened or started independently or launched in connection with the Developers Integrated Development Environment (IDE), see FIG. 13D. If launched independently, the interface opens with the issues filter form, see FIG. 11G previously discussed. If launched through the user's IDE environment, the interface illustrates a plurality of tasks assigned to the respective user as in exemplary FIG. 12. The exemplary list of tasks can include line items from design specifications, and defect issues from past failures.

Clicking a specification item in screen 54c will bring up a specification item form, see FIG. 13A. The specification item form of FIG. 13A illustrates the text of the specification and links to its custom or related data. If the user clicks a defect issue, an individual issue form, see FIG. 17B, will be brought up for review and analysis. Both the screens of FIGS. 13A and FIG. 17B can include a “resolved” light button. Clicking on that button enables the developer to document source code changes for a software development project, on a Source Code Change form, see FIG. 13B for specified changes or for defect resolutions, see FIG. 13C.

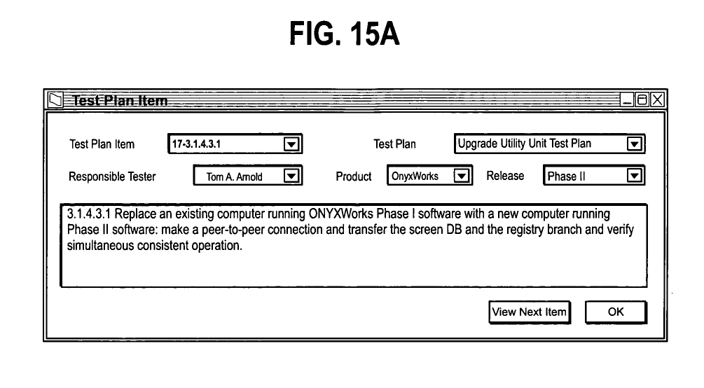

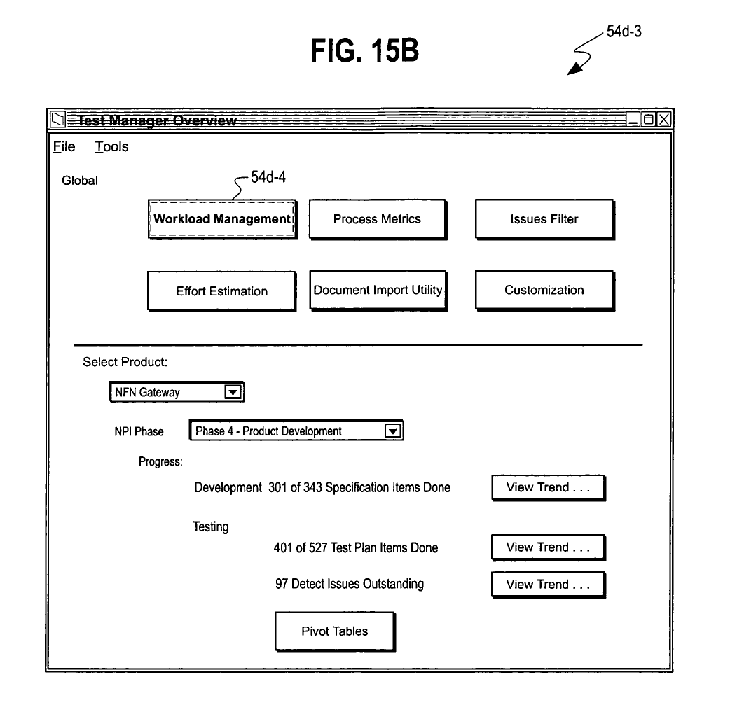

The entry Test Management screen 54d is presented in FIG. 14. A command or light button 54d-1 is provided for opening the Status Report form, previously discussed. The Process Metrics screen previously discussed, can be opened 54d-2. A list of tasks to be performed is also presented. The tasks can include test Plans to be written, Test Plan items, see FIG. 15A, to be assigned, Issue retests to be assigned as well as Test Plan items or retests the user assigned to himself or herself.

Screen 54d can be continued to screen 54d-3 of FIG. 15B. The Status Reports 54d-1 and Process Metrics 54d-2 screens are the same as in the Development Manager screen of FIG. 10.

From the screen 54d-3 of FIG. 15B, the user can launch a Workload Management Tool, 54d-4 which is a similar to the one available, button 70a-1 in the development managers screen 54b (see FIG. 11A). In the present instance items to be assigned are related to testing including Test Plan items and Issue retests.

The Entry Tester screen 54e is illustrated in FIG. 16. It provides the users with a view of all Test Plan items and Issue Retests assigned to them. Selecting any Test Plan item will bring up the item in the Test Execution view 54e-1 see FIG. 17A. Selecting an Issue will bring up an individual issues form, see FIGS. 17B,C and associated screens 54e-3 and 54e-5.

Using Test Execution screen 54e-1, see FIG. 17A, a user can input results, record failures, capture new failure modes, search for previous documentation of defects, add a new issue, move on to the next assigned test plan item or exit the form. Test results can be recorded in a variety of ways including tasks/fail, or as continuous variable data, or in the form of a physical file.

The Issues form, illustrated in FIG. 17B,C,D and E provides a variety of functions. Relative to FIG. 17B, information associated with particular defects/modification/corrective action request can be captured and displayed. The same screen also illustrates resolution information and regression scripting information as required.

Clicking on the analysis tab, see FIG. 17C, test related information can be accepted or displayed. These include injection/detection defect analysis, test capability analysis, severity assessment, as well as probability/frequency of occurrence assessment. A dialog screen 54e-7, see FIG. 17D, is provided in response to clicking on the “Dialog” tab. The screen of FIG. 17D promotes interpersonal discussions of one or more test issues between the developer or the engineer and the tester. A log can be kept of what has been discovered, what additional information is necessary, or what evidence has been gathered to attempt to isolate a problem. The on-going interaction can also incorporate inputs from the responsible engineering manager.

FIG. 17E illustrates a design failure mode search screen. The screen of FIG. 17E enables the user to determine if a given fail mode has already been listed on the design failure mode effects analysis (DFMEA). Then if not, enables the user to add a new one.

The entry Technical Support screen, FIG. 18 provides post-release feedback which can be captured in the common database 20c along with other process data. Hence, all new issues noted and discovered in the field can be fed back not to just the engineering organization but to the testing group as well.

As a result of the above-noted feedback, both the customer's immediate needs and the development organization's long-term need for continuous improvement are both served. The technical support user, when discovering a problem in the field, determines two things: First, whether the issue has been documented already and second whether the fail mode has been entered on the DFMEA list.

The screen 54f of FIG. 18 presents an issues filter screen select button 54f-1 and DFEMA screen select button 54f-2. Using the issues of the filter screen, the user can determine if a particular issue has been documented. If not, it can be added to the database 20c.

Additionally, the subject value mode may or may not have been considered or contemplated during the design phase. If the DFMEA screen select button 54f-2 can be used to check to see if the fail mode has been included therein.

It will be understood that the above set of screens and described functions are exemplary only and not limitations of the present invention. In summary, a graphical user interface in accordance with the invention provides access to data in an integrated database which data is associated with a pre-selected function such as marketing management, engineering management, necessary development, test management, testing development or post-issue customer support. Data in the database not directly associated with the respective predetermined or selected function is not presented to the user during the normal course of operation. For example, the marketing data or information would not routinely be presented to the test management as it would not be necessary to carry out the testing function.

With all of the necessary inputs stored in the database 20c, analysis software 24 is able to automatically generate various known metrics associated with software development and testing. The advantage of automatically generating this information, rather than depending on managers or analysts to manually aggregate the data and calculate the results, is that it requires no overhead. Without having to expend added resources, management will be more likely to keep track of how the organization is doing, and promptly detect and address problems. Some of the metrics include:

Software Size: Typically used as a denominator for normalizing data for project-to-project comparisons or process assessments, software size is often captured as a number of KLOC (thousands of line of code), function points (which eliminates language-specific variation), object points, use case points, or various forms of the COCOMO technique. Regardless of the method used, the data can be gathered from the database(s) 20c and used as an input to further calculations.

Development Time Distribution: Software 24 can analyze the labor hours entered by project and development phase, and aggregates the number of person-hours invested in each phase for each project. At the completion of the project, the percentage of the hours logged for each phase relative to the total number of hours spent on the project can be calculated as #hours phase x#hours project, with the percentages for each phase totaling 100. The project data can be aggregated to come up with the development process metric for development time distribution, so that management can determine where resources are best used.

Similarly, software 24 can check the calendar dates on which each phase gate passed for a particular project, and assess the calendar time spent in each phase relative to the total calendar time spent on the project.

Average Defect Leakage per 100 Fn Pts: Since the Software Size is known (see above), and the number of defects leaked from phase to phase is known via Defect Injection and Detection, the defect rate can be calculated for the process as a whole as (#Defects Detected phase x—#Defects Injected phase x−1 to x−n)/(#Total Function Points <or equivalent size metric>/100<or equivalent scope adjuster>).

Overall Field Defect Leakage: Software 24 can analyze Tech Support-derived data to count the total number of field defects and divide that by the aggregate size metric for all projects under consideration.

Productivity: Software 24 can derive this statistic either from the total number of function points produced per labor hour or the total number of functional spec items produced per labor hour, or any other deliverable numerator divided by the number hours spent producing the deliverable. This can also be broken down by phase, where the deliverable is different in each case.

Test Efficiency: Information can be derived by software 24 as #of test cases covered per test labor hour, # of functional or design specification items covered per labor hour, % code coverage per test labor hour, or any of the above per total test resource cost.

Average # of In-Process Design Changes: Software 24 can capture the number of specification changes (functional and design) in each project, normalized by size (or not), averaged over all projects over a given time frame for the organization.

Average # of System Test Iterations: Software 24 can capture the number of times, on average, a project must be submitted/resubmitted to Design Assurance.

Average # of Issue Retest Iterations: Software 24 capture as defect removal rate or bad fix rate, this captures the average number of retests it takes to close an issue (lower is better, and 1.0 is the best possible score).

Defect Removal Rate per Build: Software 24 can develop another form of defect removal rate, showing the progression of the number of outstanding issues after all retesting is completed on a given build. This is done only after the entire test plan is completed.

Software Scorecard: The data for the software scorecard are captured by software 24 in the normal workflows of time/labor documentation, defect issue entry, and defect injection/detection analysis. IDI can then capture the issue counts and labor hours to fill in the Software Scorecard form and deliver the Cost Of Software Quality metric on demand.

Thus, software 24 can automatically mine the database(s) 20c for relevant statistics and present stakeholders with useful information that otherwise would be determined through extra effort on the part of the managers, developers, testers, and tech support personnel. It will be understood that software 24 can determine additional metrics automatically without limitation. Further software 24 could be distributed across a plurality of sites or locations without limitation.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. A system comprising:
at least one database;
first software that provides pluralities of function based, interactive graphical screens;
second software that receives queries from the first software and responsive thereto at least retrieves function based information from the at least one database and couples retrieved information through a respective interface to a user.

2. A system as in claim 1 where the second software includes additional software, responsive to function based information from the first software to store at least portions thereof in at least one database.

3. A system as in claim 2 where the function based screens are selected from a class which includes at least a marketing function; a development management function; a developer function; a test management function; a tester function, and a technical support function.

4. A system as in claim 1 where a user specifies a desired type of function.

5. A system as in claim 3 where a user specifies a desired type of function from the class.

6. A system as in claim 1 where the database includes project development information relative to a plurality of predetermined development functions.

7. A system as in claim 6 which includes third software for automatically determining at least one metric based on the project development information in the database.

8. A system as in claim 7 where the at least one metric is selected from a class which includes at least development time distribution; defect leakage, productivity, test efficiency, design changes, and test iterations.

9. A system as in claim 1 where the database comprises a relational database.

10. A system as in claim 9 which includes third software that selects a particular plurality of graphical screens for display in accordance with a specified function.

11. A system comprising:
a plurality of interface devices;
at least one database;
a network coupling the devices to the database;
interface software that presents a visual display at a selected device, the display providing a plurality of selectable indicia that specify a plurality of respective functions and additional software that at least presents function related information from the database on the selected device, to the exclusion of non-function related information in the database, in accordance with the selected function.

12. A system as in claim 11 where the additional software receives information entered on the selected device related to the selected function.

13. A system as in claim 11 which includes additional software for automatically analyzing data stored in the database in accordance with predetermined criteria.

14. A system as in claim 13 where the database comprises a relational database and the additional software analyses data therein in accordance with a selected metric pertaining to at least one of marketing, engineering and testing functions.

15. A method comprising:
providing a database of information for an activity that relates to a plurality of different types of functions associated with that activity;
specifying a least two different pluralities of function based graphically displayable screens;
specifying a type of function thereby specifying one of the members of the plurality;
displaying screens from at least one member of the specified plurality;
identifying function related information via a displayed screen;
retrieving the identified function related information from the multi-functional information the multi-functional information in the database exclusive of other information in the database.

16. A method as in claim 15 where the providing includes providing a relational database which includes the information.

17. A method as in claim 15 where the activity comprises product development and the information includes marketing, development and test information relative to a selected product development, and including:
providing function related information pertaining to open development issues.

18. A method as in claim 17 which includes only providing information pertaining to open development issues that correspond to a specified function.

19. A method as in claim 18 which includes specifying a function by a log-on process.

20. A method as in claim 18 which includes automatically analyzing information in the database in accordance with one or more predetermined metrics.
